(19) United States
(12) Patent Application Publication
(10) Pub. No.: US 2011/0168337 A1
(43) Pub. Date: Jul. 14, 2011

(54) ADJUSTABLE MODULAR WINDOW DRESSING SYSTEM AND METHOD FOR INSTALLING THE SAME

(76) Inventor: Alain Guillotte, Blainville (CA)

(21) Appl. No.: 12/989,513

(22) PCT Filed: Apr. 23, 2009
(86) PCT No.: PCT/CA2009/000482

§ 371 Date: Mar. 23, 2011

Related U.S. Application Data
(60) Provisional application No. 61/047,305, filed on Apr. 23, 2008.

(51) Int. Cl. E06B 9/266; E06B 9/24; E06B 3/70; B23P 11/00

(52) U.S. Cl. 160/92; 160/371; 160/181; 160/89; 29/428

(57) ABSTRACT

A window dressing system for installation within a window structure is disclosed. The window dressing system has at least one dressing element. The dressing element includes a frame structure and engagement members outwardly extendable from the frame structure and adapted to forcibly engage a surface of the window structure to maintain the dressing element fixed within the window structure. The engagement members on the frame are arranged in manner that several dressing elements may be modularly attached together. The engagement members may be replaced by linking members when attaching adjacent dressing systems together. A method for installing such a window dressing system is also disclosed.

### FIELD OF THE INVENTION

The invention generally relates to window dressing systems. More particularly, it relates to an adjustable modular window dressing system, as well as a method of installing the system within a window frame.

### BACKGROUND OF THE INVENTION

In general, blinds or slatted shutters made of wood for installation in window frames must be individually ordered and custom-made for each window frame. A client wishing to install blinds or shutters is therefore responsible for any mistake in measuring the dimension for installation of the blinds or shutters. Moreover, since the blinds are custom-made for a specific installation, these blinds are not removed from the home when the owner moves away. People who rent their homes are also reluctant to invest in such window dressing systems for the same reasons.

Orders for blinds at manufacturing locations typically require a delivery delay of seven (7) to twenty-one (21) days.

Moreover, all blinds or shutters systems presently on the market require being fixed to casings or window frames using different attachment mechanisms. These mechanisms are often screwed into the structures, therefore damaging any frame or support structures.

Slats used in slatted shutters presently being sold on the market are typically installed within their frames in a permanent manner. The slats can therefore not be easily removed in order to facilitate painting or staining thereof.

U.S. Pat. No. 6,119,756 discloses a window blind insert that can be installed in a window frame. However, this insert is adapted to fit into a window insert receptacle already provided on the frame for screen structures or the like. Such a system is not adaptable to different window sizes.

U.S. Pat. No. 2,474,434 discloses a combination support for shades, curtains and drapes. It uses an extension rod to maintain the support within a window frame structure.

U.S. Pat. No. 5,547,010 discloses a curtain frame adapted to be mounted in windows of various sizes. The vertical members and the cross members are slidably adjusted within the corner members to fit a window of a selected size with the curtain rods being self adjusted in length without altering its spacing from the upper cross member. Hinges allow the frame to be moved between a closed position covering the window and an open position uncovering the window.

In U.S. Pat. No. 6,626,227, an apparatus for a window shutter system is disclosed. The window shutter system includes a plurality of shutter frames. The shutter frames include a plurality of couplers. Each coupler has at least two extensions for connecting adjacent elongate members. These extensions are adapted to interlock with the receiver of an associated elongate member such that the elongate members and the couplers cannot rotate relative to one another. The frames are also configured so as to allow the vertical and horizontal sections of the frame to be uncoupled and recoupled without the use of an adhesive or other permanent coupling means. In addition to the shutter frames, the shutter system also includes a hinge that may be used to couple the system to a window frame.

U.S. Pat. No. 5,307,858 discloses a universal window shutter system that includes vertical frame member components and horizontal frame member components to be assembled to form shutter panel frames which are covered with shutter panel covers and which are hingeably interconnected to form shutter units to be installed in a window opening. Frame member components are available in various lengths and are adjustable in length.

Also known to the Applicant are the following patent documents: U.S. Pat. No. 1,559,081 (FISCHER), U.S. Pat. No. 6,026,886 (DIAMOND-MARTINEZ), U.S. Pat. No. 6,131,867 (MALLEK), U.S. Pat. No. 6,802,168 B1 (MINNICK), U.S. Pat. No. 7,134,470 B2 (McCANCE) and US 2008/0017332 A1 (DALY).

However, there is still presently a need for an improved window dressing system that addresses at least one of the following requirements:
Minimized damage to window frames and casings;
Does not need to be custom-made;
Easy assembly, disassembly, finishing and clipping;
Cost savings through installation by the purchaser only;
May be entirely disassembled, thus making shutter slats easy to stain or paint;
Offers multiple installation configurations; and
Offers a means of a square installation of the structure within a window frame that may not be square.

### SUMMARY OF THE INVENTION

The present invention in its different embodiments addresses at least one of the above-mentioned needs.

More particularly, the present invention provides a window dressing system for installation within a window structure, the window dressing system comprising at least one dressing element, the dressing element comprising:
a frame structure;
a plurality of engagement members symmetrically arranged on the frame structure, outwardly extendable from the frame structure and adapted to forcibly engage a surface of the window structure to maintain the dressing element fixed within the window structure; and
a plurality of linking members,
   wherein the plurality of engagement members are removably attached to the frame structure to allow modular assembly of two or more adjacent dressing elements through replacement of selected engagement members with corresponding linking members linking the two or more adjacent dressing elements.

The present invention also provides an assembly kit for installation of a plurality of window dressing elements within a window structure, each of the dressing elements comprising:
a frame structure;
a plurality of engagement members symmetrically arranged on the frame structure, outwardly extendable from the frame structure and adapted to forcibly engage a surface of the window structure to maintain the dressing element fixed within the window structure; and
a plurality of linking members,
   wherein the plurality of engagement members are removably attached to the frame structure to allow modular assembly of two or more adjacent dressing elements through replacement of selected engagement members with corresponding linking members linking the two or more adjacent dressing elements.

The present invention also discloses a method of installing a modular window dressing system within a window structure comprising the steps of:
a) providing the window dressing system comprising at least one dressing element, the dressing element comprising:
   a frame structure;
   a plurality of engagement members symmetrically arranged on the frame structure, outwardly extendable from the frame structure and adapted to forcibly engage a surface of the window structure to maintain the dressing element fixed within the window structure; and
   a plurality of linking members,
b) positioning the dressing element within the window structure; and
c) extending at least one of the plurality of engagement members outwardly to forcibly engage a surface of the window structure to maintain the dressing element fixed within the window structure,
   wherein the plurality of engagement members are removably attached to the frame structure to allow modular assembly of two or more adjacent dressing elements through replacement of selected engagement members with corresponding linking members linking the two or more adjacent dressing elements.

The present invention provides a frame system preferably made of wood, which can be adjustably and modularly installed within window frames for insertion of shutters principally, but also for other applications such as decorative panels or any other window dress or covering materials.

The system according to the present invention comprises several components that can be assembled in different configurations according to specific consumer tastes and requirements. A principal advantage of the system according to the present invention is the fact that it does not have to be custom-made for each installation. The system can be entirely disassembled, adjusted and does not require the use of damaging drilling in window frames or casings in order to complete installation.

Preferably, the system is adjustable from ½″ up to 6″ along the width. The system is also adjustable for different window heights along the window opening which yields a significant flexibility for any adequate installation. The system can thus be adapted to window openings of various dimensions.

Moreover, the system according to the present invention is preferably pre-assembled. Different system heights, modules or accessories can then be available in inventory. Consumers can then purchase immediately any elements required for a particular installation.

Preferably, the system according to the present invention is fixed and maintained in place by engagement members exerting a force against the window frame which locks the system within the window casing and thus does not damage the window casing or frame. The system may be installed vertically or horizontally within the window casing.

Preferably, the system according to the present invention, when used for installation of slatted shutters, can be completely disassembled in order to facilitate removal of individual slats in order to provide a desired finish to the slats. The removal, staining or painting process of the shutters can be repeated subsequently when the colors of surrounding structures change and there is a desire to update the colors of the shutters.

A non-restrictive description of preferred embodiments of the invention will now be given with reference to the appended drawings.

### DESCRIPTION OF THE DRAWINGS

FIG. 1 includes perspective and parts views of a first embodiment of the present invention, a mounting of the system with a simple frame;

FIG. 2 is a perspective view of another embodiment of the present invention, a mounting of the system including two frames without spacing;

FIG. 3 includes perspective and detailed views of another embodiment of the present invention, a mounting of the system including two frames with spacing;

FIG. 4 includes perspective and detailed views of another embodiment of the present invention, a mounting of the system with a sash capability on a frame;

FIG. 5 includes perspective and detailed views of another embodiment of the present invention, a mounting of the system with a double sash capability on a frame;

FIG. 6 includes perspective and detailed views of another embodiment of the present invention, a mounting of slideable system;

FIG. 7 is an assembly view of a blind to be used with another embodiment of the present invention;

FIG. 8 is an assembly view of an insertion panel to be used with another embodiment of the present invention;

FIG. 9 is an assembly view of a stop structure for a panel or a blind to be used with another embodiment of the present invention;

FIG. 10 is an assembly view of a surface attachment to be used with another embodiment of the present invention;

FIG. 11 is an assembly view of a top element and valance to be used with another embodiment of the present invention;

FIGS. 12a to 12d are perspective views of another embodiment of the present invention showing a sash shutter capability;

FIGS. 13a to 13d are perspective views of slotted shutters according to another embodiment of the present invention;

FIGS. 14a and 14b are perspective views of slotted shutters according to another embodiment of the present invention;

FIG. 15 is a perspective detailed view showing a vertical interface of an engagement member with a window frame;

FIG. 16 is a perspective view showing a double installation of a fixed shutter and a deployable blind with a same frame;

FIG. 17 is a perspective detailed view showing a horizontal interface of an engagement member with a window frame;

FIGS. 18A to 18C are perspective views showing different configurations of a mounting of the system including two frames; and

FIGS. 19A to 19F are front views illustrating installation of a mounting in front of a frame that does not provide an internal casing.

### DETAILED DESCRIPTION OF PREFERRED EMBODIMENTS

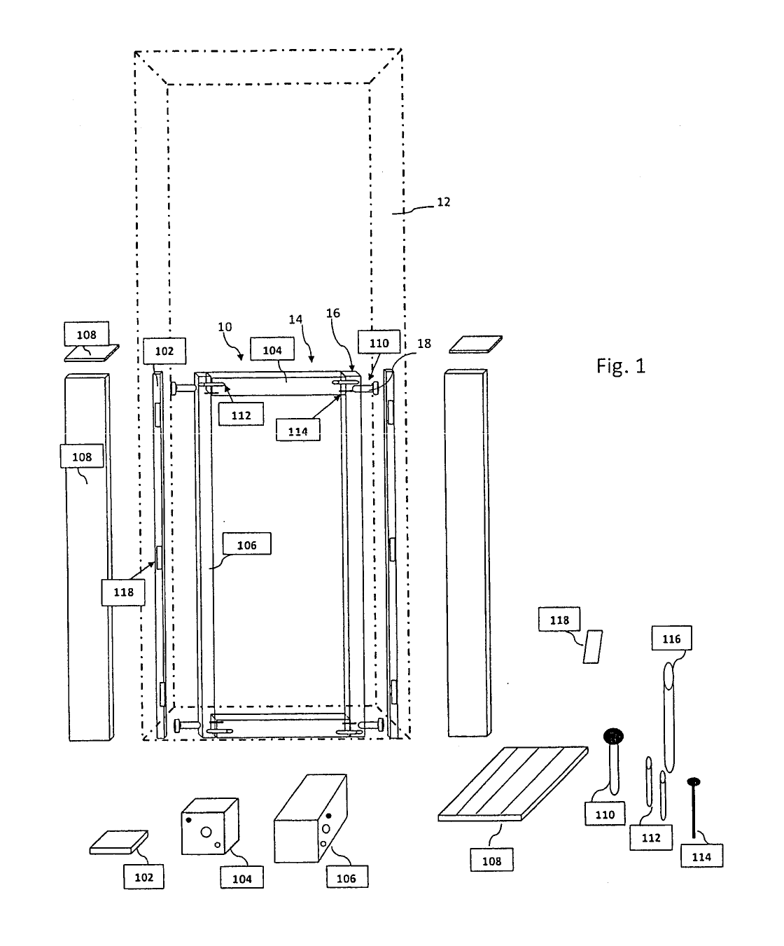

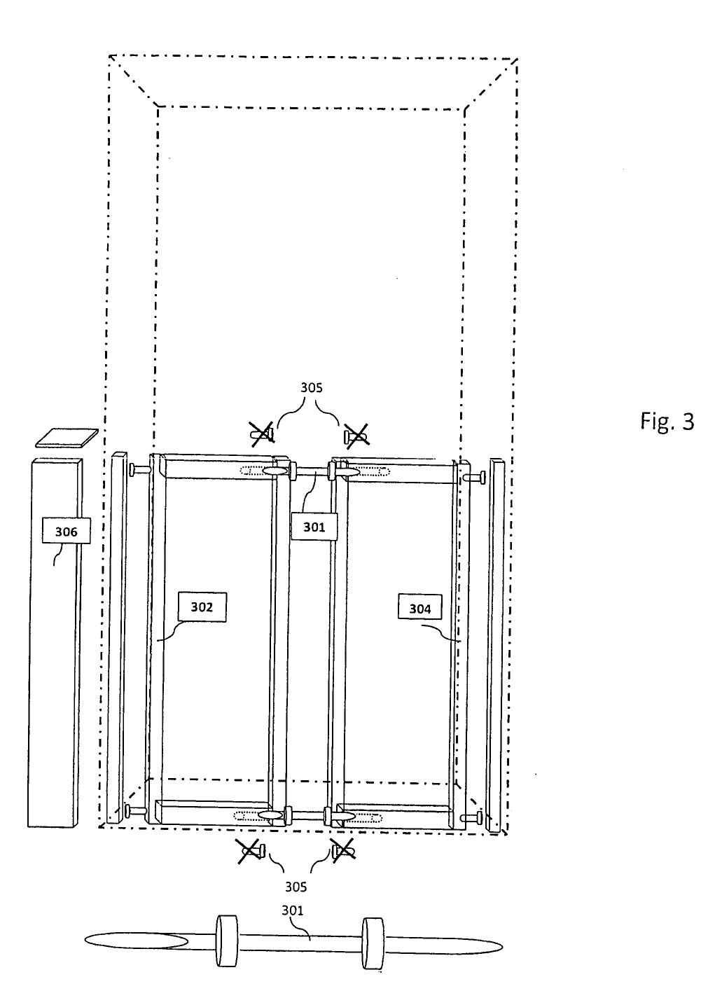

As shown in FIG. 1, the present invention provides a window dressing system 10 for installation within a window structure 12. The window dressing system comprises at least one dressing element 14. The dressing element 14 comprises a frame structure 16 and a plurality of engagement members 18 symmetrically arranged on the frame structure 16. The engagement members 18 are outwardly extendable from the frame structure 16 and adapted to forcibly engage a surface of the window structure 12 to maintain the dressing element fixed within the window structure 12. As better shown in FIG. 3, the plurality of engagement members 18 are removably attached to the frame structure to allow modular assembly of two or more adjacent dressing elements through replacement of selected engagement members 18 with corresponding linking members 20 linking the two or more adjacent dressing elements.

Preferably, the engagement members 18 are tensioning bolts and the linking members 20 are pins.

Preferably, the window dressing system further comprises finishing mouldings 108 for covering the engagement members.

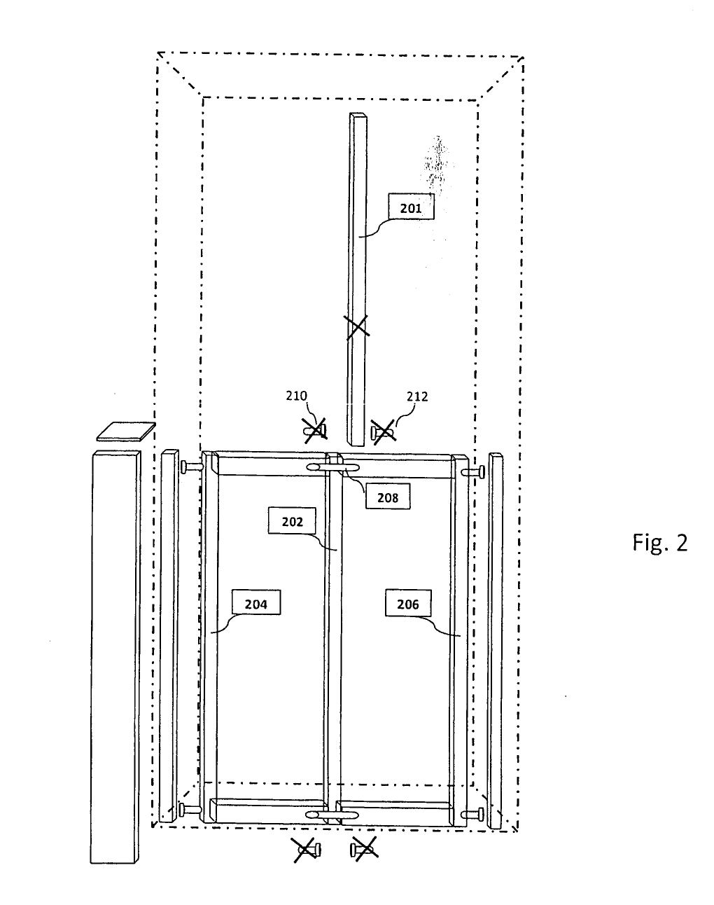

Preferably, as better shown in FIG. 2, the frame structure comprises removable frame elements 201 to allow modular assembly of two or more adjacent dressing elements through sharing of a common selected frame element 202 between two adjacent dressing elements.

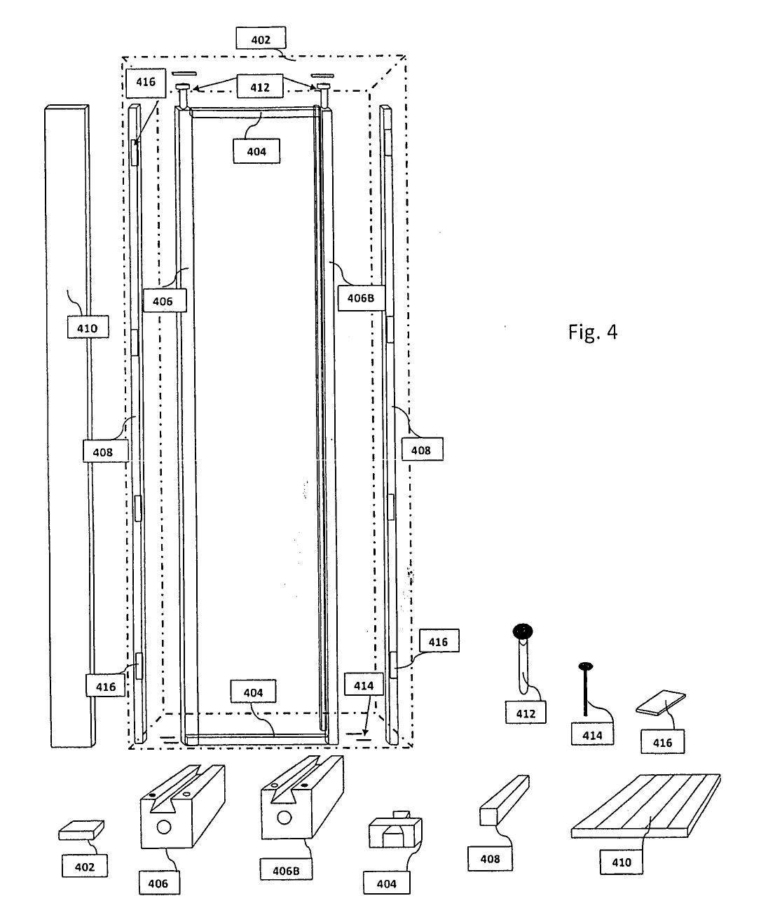

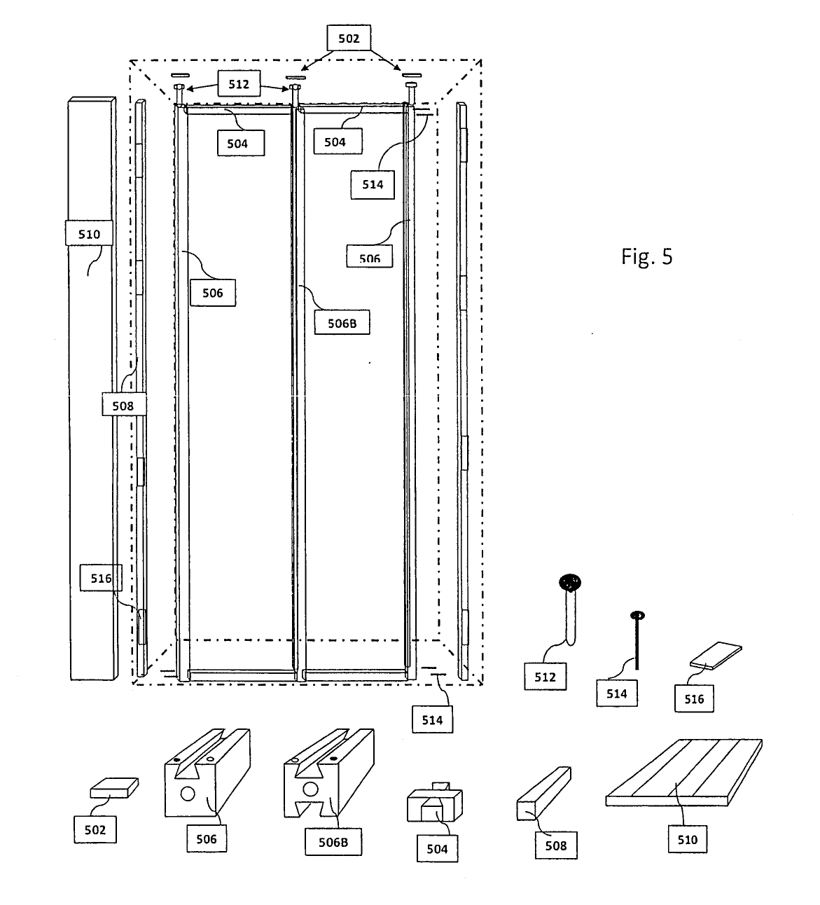

Preferably, in one embodiment of the present invention as shown in FIG. 4, the frame structure comprises an internal primary sash rail system. In yet another embodiment of the present invention as shown in FIG. 5, the frame structure comprises an internal secondary sash rail system parallel and adjacent to the primary sash rail system.

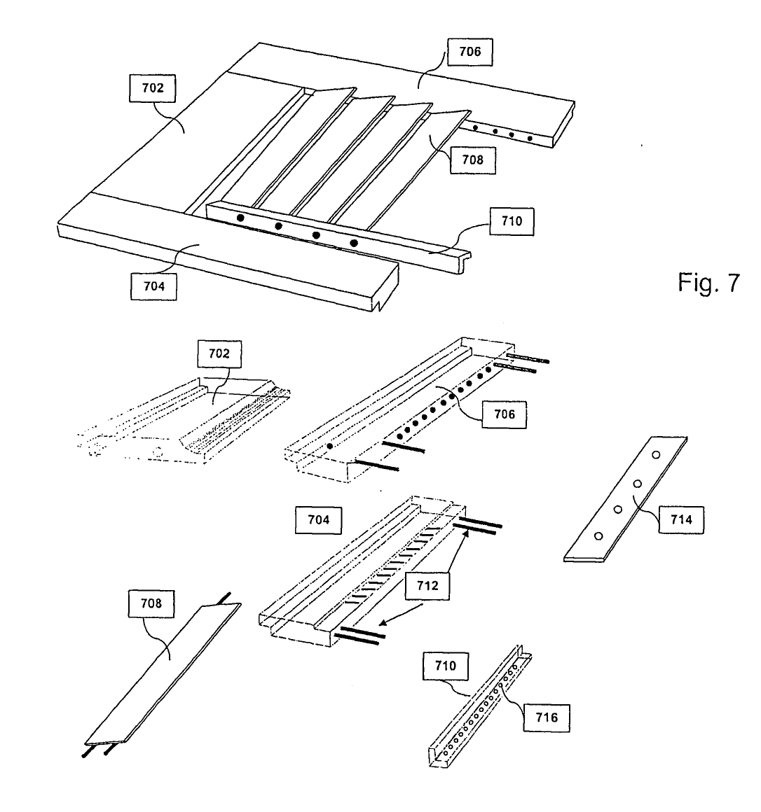

Preferably, in another embodiment of the present invention as shown in FIG. 7, the frame structure comprises a pair of side jambs 704,706 and a plurality of blind slats 708 mounted between the pair of side jambs 704,706. The plurality of blind slats 708 are removably mounted between the pair of side jambs 704,706.

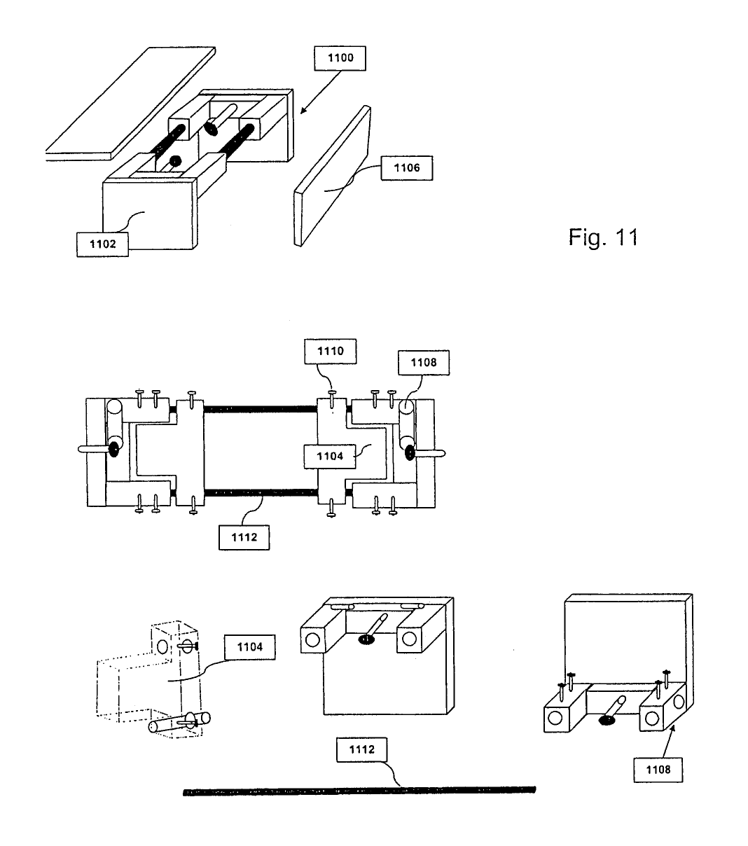

Preferably, the window dressing system further comprises a top casing dressing element 1100, as shown in FIG. 11, mounted within a top part of the frame structure. The top casing dressing element is selected from the group consisting of rollable drapes, drapery poles, blind fixtures and decorative panel support structures.

Preferably, the window dressing system further comprises a valance covering the top casing dressing element.

Preferably, in another embodiment of the present invention, the window dressing system further comprises a door hingedly mounted within the frame structure.

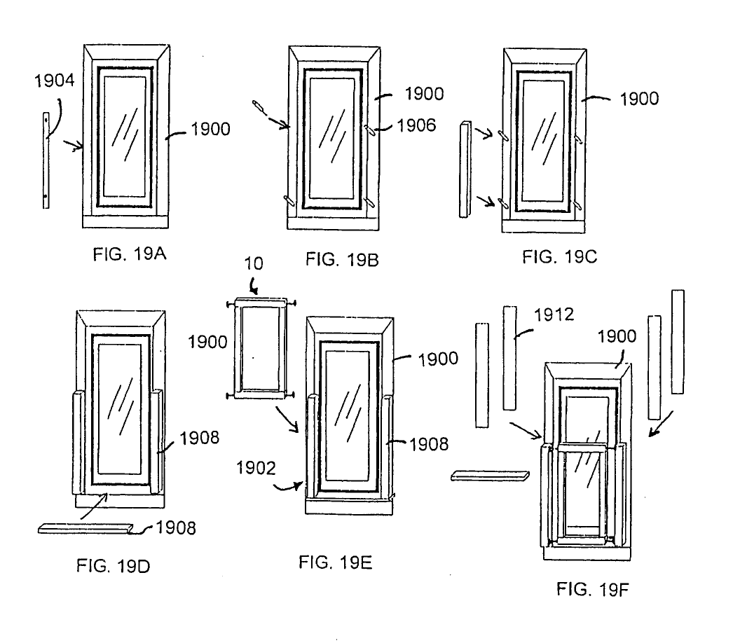

Preferably, when the window structure does not have a casing, as shown in FIGS. 19A to 19F, the window dressing system further comprises attachment base structures mounted within the window structure and fixed thereto for receiving the engagement members.

The present invention also provides an assembly kit for installation of a plurality of window dressing elements as described above.

According to the present invention, there is also provided a method of installing a modular window dressing system within a window structure comprising the steps of:
a) providing the window dressing system comprising at least one dressing element, the dressing element comprising:
   a frame structure;
   a plurality of engagement members symmetrically arranged on the frame structure, outwardly extendable from the frame structure and adapted to forcibly engage a surface of the window structure to maintain the dressing element fixed within the window structure; and
   a plurality of linking members,
b) positioning the dressing element within the window structure; and
c) extending at least one of the plurality of engagement members outwardly to forcibly engage a surface of the window structure to maintain the dressing element fixed within the window structure,
   wherein the plurality of engagement members are removably attached to the frame structure to allow modular assembly of two or more adjacent dressing elements through replacement of selected engagement members with corresponding linking members linking the two or more adjacent dressing elements.

FIGS. 2 to 19F illustrate different embodiments of the present invention and/or different components to be used with the window dressing system.

The system is designed around three (3) basic element structures:
A frame mounting structure
A window sash mounting structure
A sliding mounting structure

The three (3) above-mentioned structures use a same fixing concept. The structure uses engagement members exerting pressure on the surrounding window frame. These engagement members are typically screws placed on the exterior extremities of the structures that once inserted within the window casing and are unscrewed, exert a force on the inside of the casing, thus fixing the window dressing within the casing.

The structure of the frame mounting system is useful for window dressing of half-windows and is therefore mounted horizontally within the window casing. The sash window mounting is used for window dressing along the height of the window and is therefore mounted vertically within the window casing.

The structure of the sliding mounting system is used for window dressing of half-windows having large surfaces and is therefore mounted horizontally within the window casing.

Preferably, additional elements can be added to the window dressing system according to the present invention and include, among others, decorative panels and top casings.

Preferably, two (2) variations of decorative panels may be used. The first consists of panel shutters and the second consists of framing panels to be inserted with various finishes and materials. The panels can be mounted in the three (3) above-mentioned mounting structures in two (2) manners. The first manner is as a simple door or foldable door within the frame structure. The second possibility is to mount the panels within railing structures in a sash-type window structure or within rails of a sliding mounting system.

A top casing dressing element can also be used to fix a dressing element on the top of a window frame structure. It is adjustable in a manner that can be adjusted telescopically and can be used with various different modules such as a rollable drape, a pole for drapery, a means for fixing blinds or a means for fixing a decorative panel.

The system according to the present invention can be installed on windows without casings. In this other preferred embodiment of the present invention, specially designed attachment structures required for a surface mounting must be used on the window frame. In such situations, the attachment structures have to be fixed and screwed-in to the window frame as shown in FIGS. 19A to 19F.

Installation of a secondary frame or sash window are options that are available according to the size of the opening of the window to be dressed or the desired decorative effect. In applications where it is desired to insert a secondary frame structure, the window dressing system according to the present invention can be installed one beside another without any spacing between the two, thanks to linking structures between each exterior frame structure. If any installation application requires spacing between the window dressing systems, a special joining adapter can be used. Installation of a secondary sash window structure can be simply added by installing the window dressing system on top of the mounting structures. This method does not offer any spacing between the different window dressing systems. When spacing is desired between the sections of the structures, each window dressing system must be installed with the desired spacing between each system and therefore no additional component is required for the installation.

The following sections list the various items illustrated in FIGS. 1 to 11 illustrating different embodiments and components of the present invention, as well as general notes related to the figures. (The reference numbers refer to different elements on the figures).

### FIG. 1—Mounting of the System on a Simple Frame

102—The casing protective elements—the moulding support structures are 0.5″×1″
104—The upper and lower cross-beams are 1-½″×1-½″
106—The side jambs are 1-½″×1-½″
108—The finishing mouldings are ¼″×3½″
110—The four (4) tensioning bolts are ¼″×4″
112—The four (4) pins are ¼″×1-½″
114—The four (4) screws for fixing the beams are No. 8 screws that are 2-¼″
116—Two (2) ¼″×6″ pins in order to replace the two (2) right-hand screws for installation of a second window dressing system
118—An adhesive ribbon and ½″ Velcro™
Note: The lengths and widths of the elements vary according to the defined dimensions of the kit.
   FIG. 2—Mounting System 2 Including Frames without Spacing
The left-hand jamb 201 of frame 206 is removed in order to connect the right-hand jamb 202 of principal frame 204.
The tensioning screws 210 on the right are removed from frame 204 and replaced by pins.
The tensioning screws 212 on left-hand side are removed from frame 206 and replaced by two pins 208 measuring ¼″×6″.
Note: The lengths and widths of the elements vary according to the defined dimensions of the kit.
   FIG. 3—Mounting System 3 Including Frames with Spacing
The right-hand side engagement members 305 are removed from frame 302 and replaced with adjustable linking spacers/adaptors 301.
The left-hand side engagement members 305 are removed from frame 304 and replaced with spacers 301.
An additional finishing moulding 306 is installed on the central portion.
Note: The lengths and widths of the elements vary according to the defined dimensions of the kit.
   FIG. 4—Mounting of the System with a Sash Capability on a Frame
402—The casing protective plates are ¼″×1″×1″
404—The upper and lower cross-beams are ¾″×1-½″
406—The side sash-type jambs are 1-½″×1-½″
408—The supports for the lateral mouldings are ½″×½″
410—The finishing mouldings are ¼″×3-½″
412—The tensioning bolts are ¼″×4″
414—The four (4) screws for fixing the cross-beams are No. 6 screws that are 2″
416—½″ Velcro™ Ribbon
Note: The lengths and widths of the elements vary according to the defined dimensions of the kit.
Note: The system can also be used for a full-height window.
   FIG. 5—Mounting of the System on a Frame with a Double Sash Capability
502—The casing protective plates are ¼″×1″×1″
504—The upper and lower cross-beams are ¾″×1-½″
506—The side sash-type jambs (506 and 506B) are 1-½″×1-½″
508—The supports for the lateral mouldings are ½″×½″
510—The finishing mouldings are ¼″×3-½″
512—The tensioning bolts are ¼″×4″
514—The eight (8) screws for fixing the cross-beams are No. 6 screws that are 2″ (the screws are placed at an angle towards the exterior)
516—½″ Velcro™ Ribbon
Note: The lengths and widths of the elements vary according to the defined dimensions of the kit.
Note: The system can also be used for a full-height window.

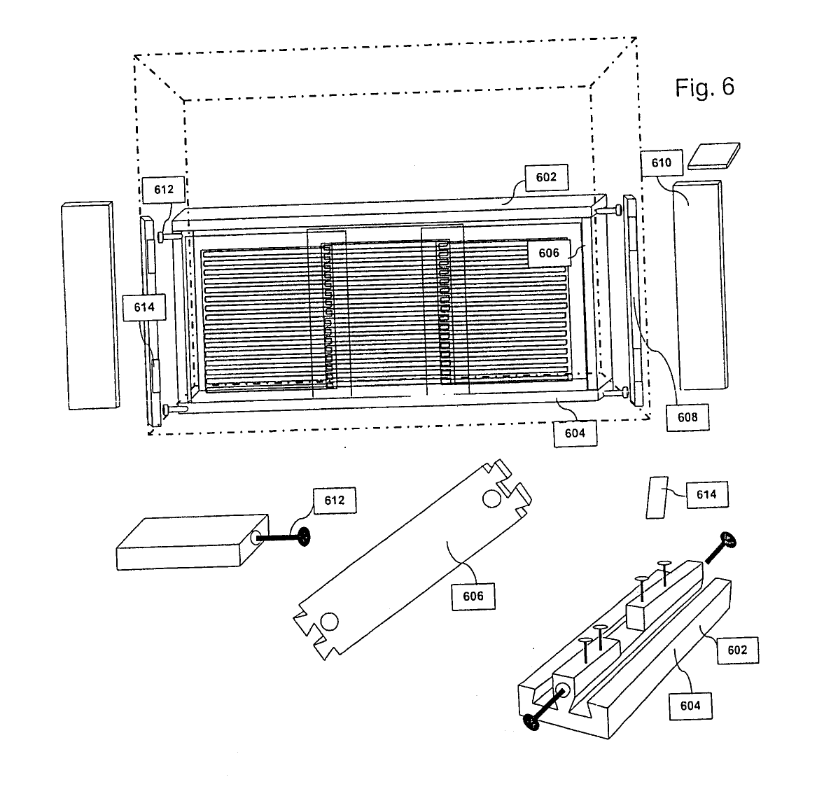

### FIG. 6—Mounting of Slideable System

602—Top rail of 1-½″×2-½″ with a deeper Dove Tail to allow insertion of slats
604—Bottom rail of 1-½″×2-½″
(Note: Each rail has a Dove Tail notch sized ½″ at the opening×½″ deep for Rail 604 and 1″ deep for Rail 602)
606—The side jambs are 1-½″×2-½″ and have a Dove Tail profile
(Note: The Dove Tail on side A is 1″ long, the one on side B is ½″ long and two holes for the tensioning bolts)
608—Supports for lateral mouldings are ½″×2-½″
610—The finishing mouldings are ¼″×3-½″
612—The tensioning bolts are ¼″×4″
614—½″ Velcro™ Ribbon

### FIG. 7—Assembly of a Blind

702—The upper and lower cross beams are ¾″×2½″
704—The right side jamb is ¾″×1-½″
706—The left side jamb is ¾″×1-½″
708—Slats that are ¼″×1-¼″-2-¼″-3-¼″
710—Slat adjustment bar ¼″×¾″×¾″
712—Eight (8) pins that are ⅛″×1-¼″
714—Slat retention bar on jamb B
716—Retaining screw for the adjustment bar No. 4×½″
Note: The lengths and widths of the elements vary according to the defined dimensions of the kit.

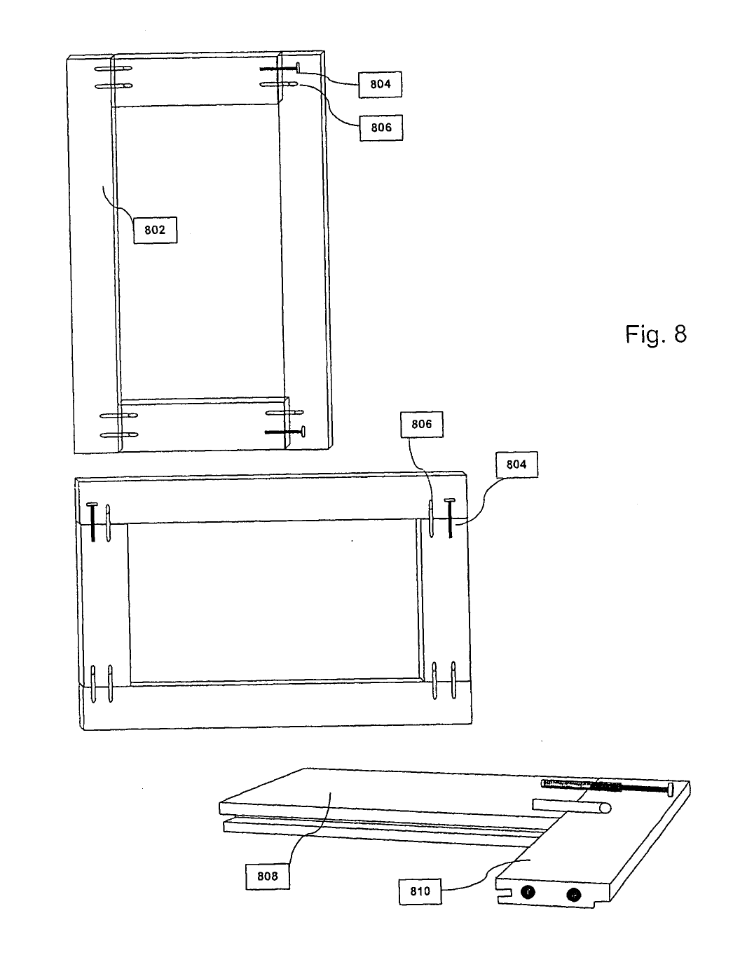

### FIG. 8—Assembly of an Insertion Panel

802—The entire frame is ¾″×2-½″
804—The two (2) assembly screws are No. 6×3″
806—The six (6) assembly pins are ⅛″×1-¼″
808—Internal frame slots of ¼″×½″ for insertion of glass
810—The external frame notch is ½″×¼″ all around the frame
Note: The lengths and widths of the elements vary according to the defined dimensions of the kit.
Note: The same frame may be mounted vertically or horizontally.
Note: The side of the frame with the screw is used to disassemble the frame for insertion of the glass. This side of the frame must not be glued when assembling the frame at the factory.

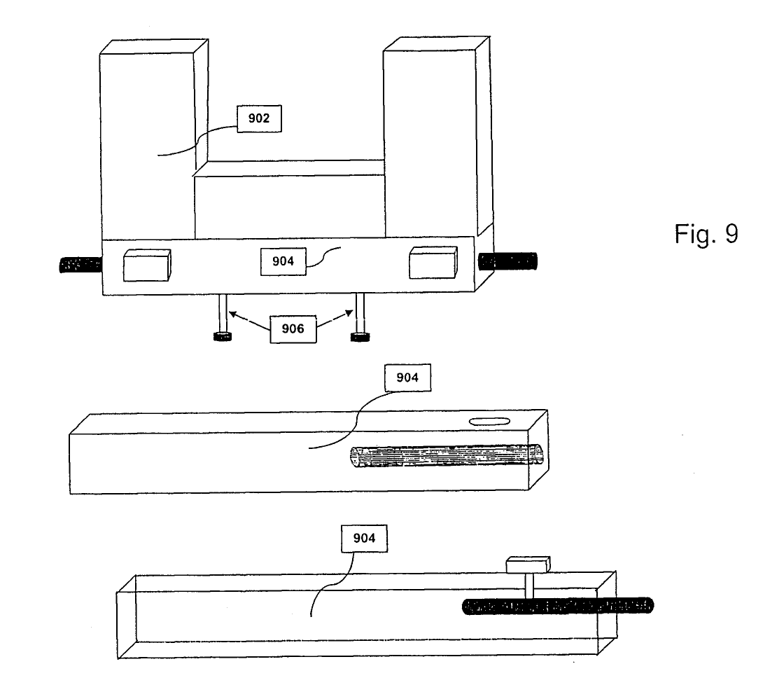

### FIG. 9—Stop Structure for Panel or Blind

902—Panel or blind ¾″×1-½″
904—Stop structure ½″×½″×various lengths
906—Panel or blind fixing screws that are No. 8×1″
Note: The lengths vary according to the dimensions of the panels and blinds.
Note: The length must be ¼″ shorter than a panel.

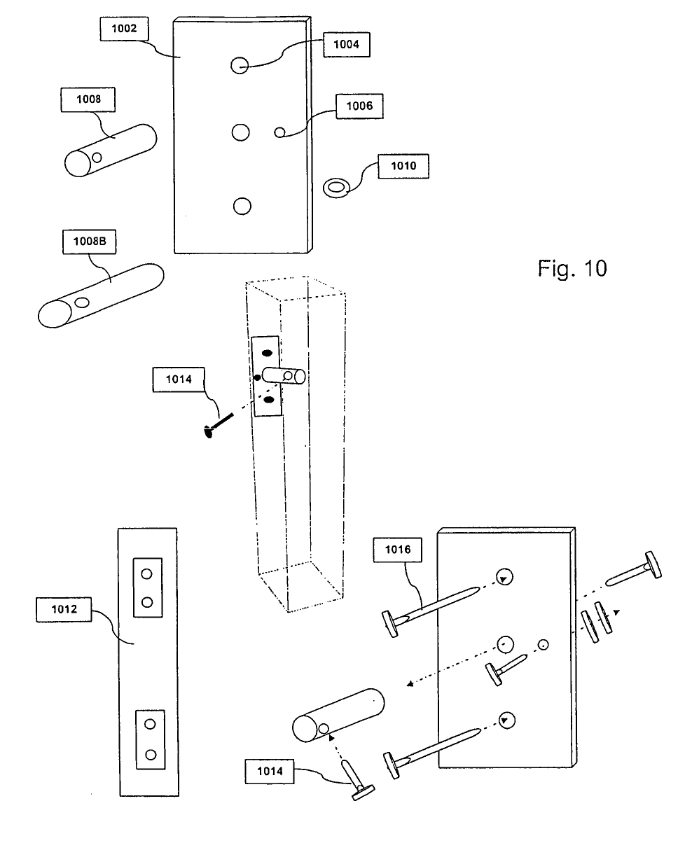

### FIG. 10—-Surface Attachment

1002—Mounting plate 1-¼″×2-½″×⅛″
1004—The three (3) holes 1004 must be reamed. The holes are made for No. 8 screws×2-½″
1006—The hole 1006 must be reamed. The hole is made for a No. 6 screw×¾″
1008—Standard attachment pin 1-¼″×½″—1008B—is a 2-¼″×½″ pin for attachment of the top casings
1010—A spacing washer of ⅜″× 1/16″ in thickness
1012—A mounting template for installation of the surface attachments is made of cardboard
1014—Fixing screw of the attachments to the jambs No. 8×1″
1016—Fixing screw of the attachments to the frames No. 8×2-½″
Note: The pin must be longer.

### FIG. 11—Top Element and Valance

1102—Window telescopic top element
1104—Adjustable block for attachment
1106—Two (2) finishing mouldings ¼″×3-½″
1108—½″ hole for the support pin of the mounting surface
1110—Retaining screw No. 8-¾″×1″
1112—Dowels ½″×48′
Note: The system is cut according to the desired dimension.
Note: The mounting surface attachment must be mounted horizontally on the frame and the dowel must be longer than other dowels used in other models.

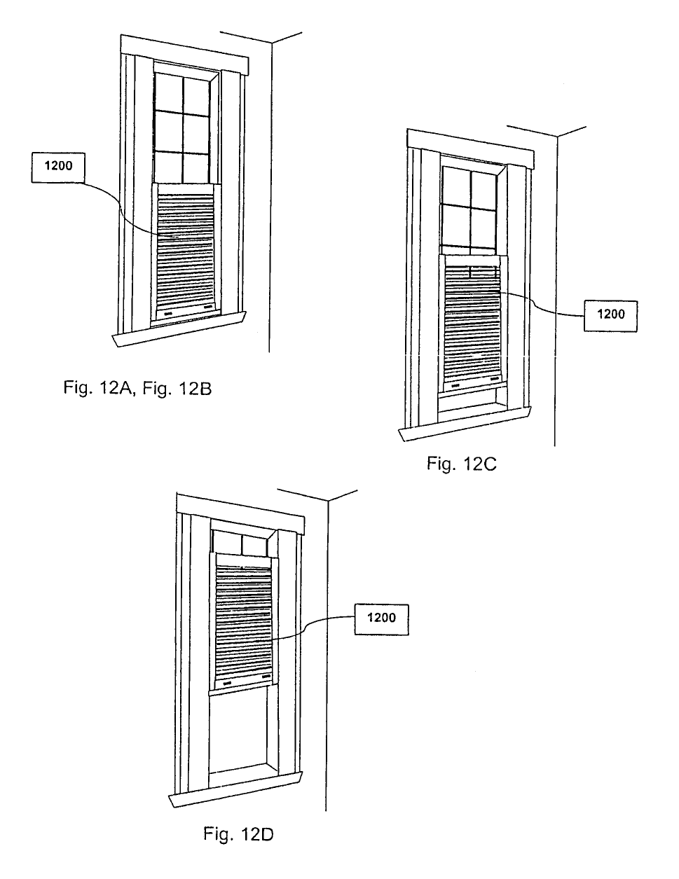

FIGS. 12a to 12d show different views of another embodiment of the present invention showing a sash shutter capability of the system 1200, as the system can be displaced along a height of the window frame structure.

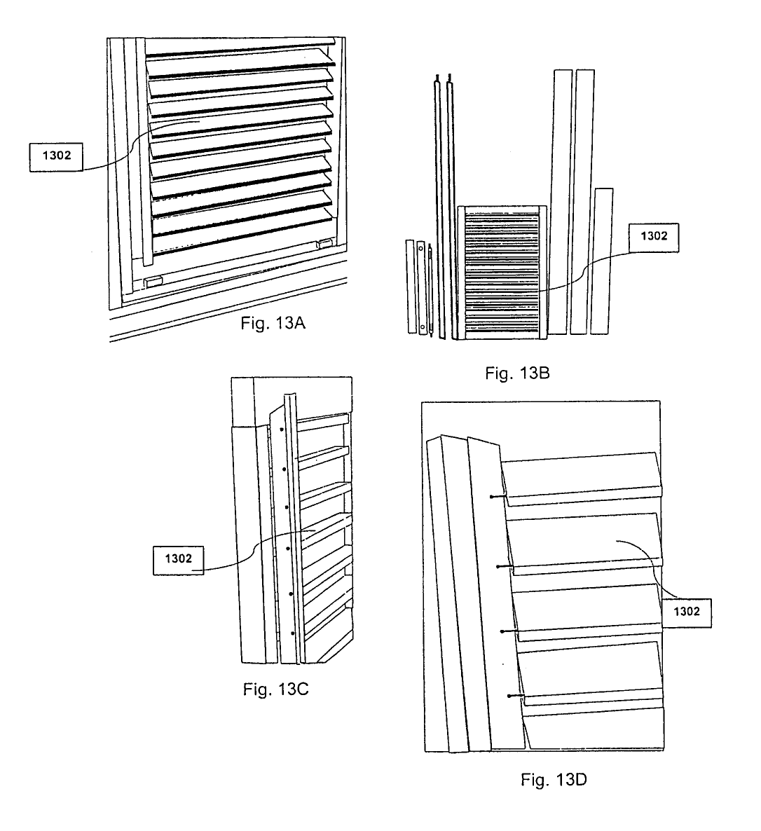

FIGS. 13a to 13d are perspective views of slotted shutters 1302 used in a system according to another embodiment of the present invention.

FIGS. 14a and 14b are perspective views of slotted shutters 1402 used in a system according to another embodiment of the present invention. In FIG. 14B, certain shutters have been removed to illustrate how they can be easily removed for maintenance or redecorating.

FIG. 15 is a view showing a vertical interface of an engagement member 18 with a window frame 12.

FIG. 16 is a view showing a double installation of a fixed shutter 1602 and a deployable blind 1604 within a same frame.

FIG. 17 is a view showing a horizontal interface of an engagement member 18 with a window frame 12.

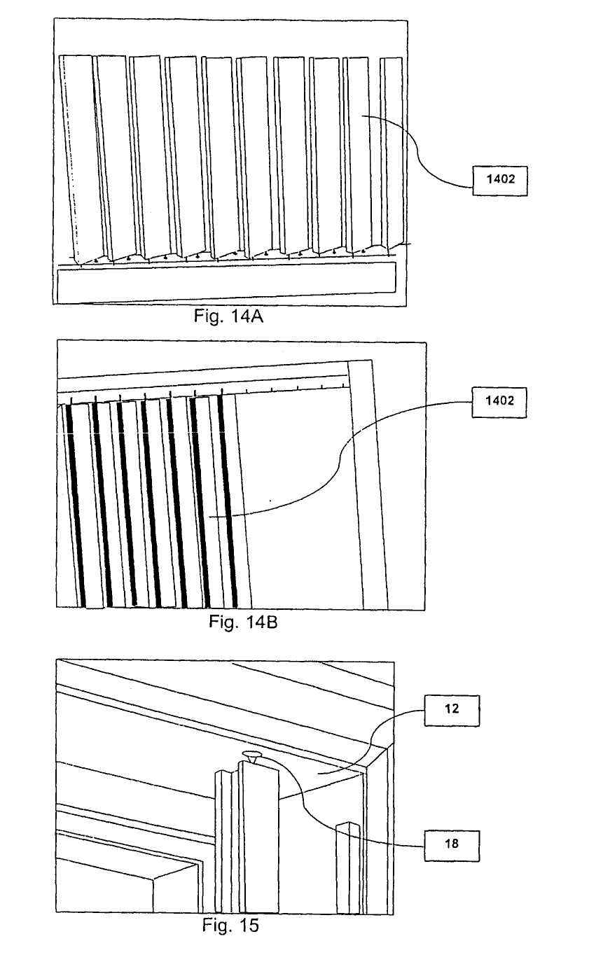

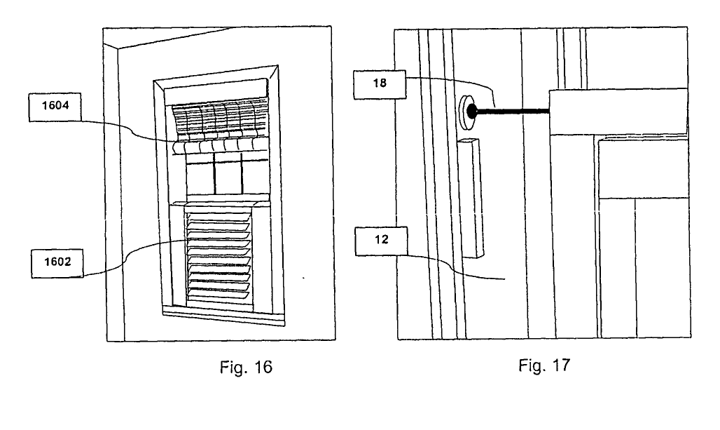

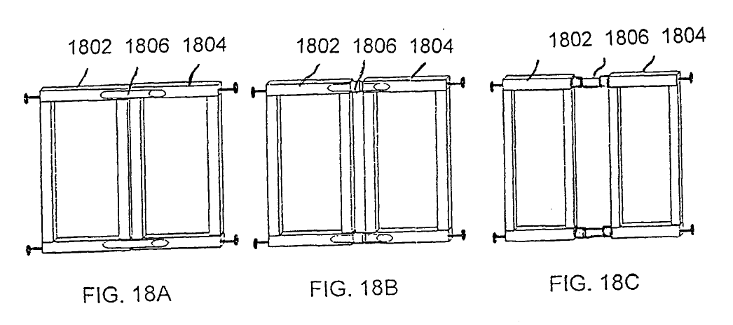

FIGS. 18A to 18C are perspective views showing different configurations of a mounting of the system including two frames 1802,1804, using different types of adjustable linking spacers/adaptors 1806 depending on the desired spacing between the frames.

FIGS. 19A to 19F are views illustrating the different steps involved for an installation of a dressing system 10 in front of a frame 1900 that does not provide an internal casing. A support structure 1902 must be installed prior to installation of the system 10, as shown in FIGS. 19A to 19E. A template 1904 may be used to position mounting members 1906 and mounting structures 1908 as shown in FIG. 19A. Mouldings 1912 can then be added over the assembled system as seen in FIG. 19F.

Although the present invention has been explained hereinabove by way of preferred embodiments thereof, it should be pointed-out that any modifications to these preferred embodiments from the scope of the appended claims is not deemed to alter or change the nature and scope of the present invention.

The present invention, and various embodiments, include components, methods, processes, systems and/or an apparatus substantially as depicted and described herein, including various embodiments, such as combinations, and subsets thereof. Those skilled in the art will understand how to make and use the present invention after understanding the present disclosure. The present invention, and various embodiments, include providing devices and processes in the absence of items not depicted and/or described herein or in various embodiments hereof, including in the absence of such items as may have been used in previous devices or processes, for example for improving performance, achieving ease and/or reducing costs of implementation. The foregoing disclosure of the invention has been presented for the purposes of illustration and description. The foregoing is not intended to limit the invention to a form or forms disclosed herein. In the detailed description of the invention for example, various features of the invention are grouped together in one or more embodiments for the purpose of straight aligning the disclosure. This method of disclosure is not to be interpreted as reflecting an intention that the claimed invention requires more features than are expressly recited in eventual claims. Rather, as the following claims reflect or as summarized in the summary of the invention, inventive aspects lie in less than all the features of a single foregoing disclosed embodiment. The present disclosure is intended to obtain rights which include alternative embodiments to extent permitted, including alternate, interchangeable and/or equivalent structures, functions, ranges or steps to those claims, whether or not such alternate, interchangeable and/or equivalent structures, functions, ranges or steps are disclosed herein, and without intending to publicly dedicate any patentable subject matter.

1. A window dressing system for installation within a window structure, the window dressing system comprising at least one dressing element, said dressing element comprising:
a frame structure;
a plurality of engagement members symmetrically arranged on the frame structure, outwardly extendable from the frame structure and adapted to forcibly engage a surface of the window structure to maintain the dressing element fixed within the window structure; and
a plurality of linking members,
wherein the plurality of engagement members are removably attached to the frame structure to allow modular assembly of two or more adjacent dressing elements through replacement of selected engagement members with corresponding linking members linking the two or more adjacent dressing elements.

2. The window dressing system according to claim 1, wherein the engagement members are tensioning bolts.

3. The window dressing system according to claim 1 or 2, further comprising finishing mouldings for covering the engagement members.

4. The window dressing system according to any one of claims 1 to 3, wherein the frame structure comprises removable frame elements to allow modular assembly of two or more adjacent dressing elements through sharing of a common selected frame element between two adjacent dressing elements.

5. The window dressing system according to any one of claims 1 to 4, wherein the frame structure comprises an internal primary sash rail system.

6. The window dressing system according to claim 5, wherein the frame structure comprises an internal secondary sash rail system parallel and adjacent to the primary sash rail system.

7. The window dressing system according to any one of claims 1 to 4, wherein the frame structure comprises a pair of side jambs and a plurality of blind slats mounted between said pair of side jambs.

8. The window dressing system according to claim 7, wherein the plurality of blind slats are removably mounted between said pair of side jambs.

9. The window dressing system according to any one of claims 1 to 8, further comprising a top casing dressing element mounted within a top part of the frame structure.

10. The window dressing system according to claim 9, wherein the top casing dressing element is selected from the group consisting of rollable drapes, drapery poles, blind fixtures and decorative panel support structures.

11. The window dressing system according to claim 9 or 10, further comprising a valance covering the top casing dressing element.

12. The window dressing system according to any one of claims 1 to 11, wherein the linking members are pins.

13. The window dressing system according to any one of claims 1 to 4, further comprising a door hingedly mounted within the frame structure.

14. The window dressing system according to any one of claims 1 to 13, further comprising attachment base structures mounted within the window structure and fixed thereto for receiving the engagement members.

15. An assembly kit for installation of a plurality of window dressing elements within a window structure, each of said dressing elements comprising:
a frame structure;
a plurality of engagement members symmetrically arranged on the frame structure, outwardly extendable from the frame structure and adapted to forcibly engage a surface of the window structure to maintain said dressing element fixed within the window structure; and
a plurality of linking members,
wherein the plurality of engagement members are removably attached to the frame structure to allow modular assembly of two or more adjacent dressing elements through replacement of selected engagement members with corresponding linking members linking the two or more adjacent dressing elements.

16. The assembly kit according to claim 15, wherein the engagement members are tensioning bolts and the linking members are pins.

17. A method of installing a modular window dressing system within a window structure comprising the steps of:
a) providing the window dressing system comprising at least one dressing element, said dressing element comprising:
a frame structure;
a plurality of engagement members symmetrically arranged on the frame structure, outwardly extendable from the frame structure and adapted to forcibly engage a surface of the window structure to maintain the dressing element fixed within the window structure; and
a plurality of linking members,
b) positioning the dressing element within the window structure; and
c) extending at least one of the plurality of engagement members outwardly to forcibly engage a surface of the window structure to maintain the dressing element fixed within the window structure,
wherein the plurality of engagement members are removably attached to the frame structure to allow modular assembly of two or more adjacent dressing elements through replacement of selected engagement members with corresponding linking members linking the two or more adjacent dressing elements.
